(19) United States
(12) Patent Application Publication
(10) Pub. No.: US 2007/0266716 A1
(43) Pub. Date: Nov. 22, 2007

(54) SYSTEMS AND METHODS FOR MONITORING USAGE OF UTILITIES

(76) Inventors: Michael J. Klein, Poulsbo, WA (US); Jerry E. Armstrong, Poulsbo, WA (US)

Correspondence Address: BLACK LOWE & GRAHAM, PLLC, 701 FIFTH AVENUE, SUITE 4800, SEATTLE, WA, 98104, US

(21) Appl. No.: 11/419,159

(22) Filed: May 18, 2006

(51) Int. Cl. G05D 23/00; G01K 13/00

(52) U.S. Cl. 62/129; 236/94

(57) ABSTRACT

Systems and methods for monitoring utility usage for a plurality of units in a building. The system includes a controller and one or more sensing devices in signal communication over existing building thermostat or other control wiring with the controller. The sensing devices sense the state of a thermostat and the air temperature in each of the plurality of units as well as the temperature of utility transport piping leading to each of the plurality of units. The controller records utility usage for each of the plurality of units based on information received from the one or more sensing devices and provides an audit trail to verify delivery of the utility and detect and report faults in the utility delivery system. System faults are transmitted to a user as an audio alert using an electronically recorded human voice.

### FIELD OF THE INVENTION

This invention relates generally to utility monitoring systems and, more specifically, to remotely accessible, centralized utility usage monitoring systems for a plurality of units in a building used to determine an accurate pro-rata cost for individual users of the utility.

### BACKGROUND OF THE INVENTION

Many multi-family properties have a common boiler (furnace) supplying heat via individual zone valves or ducting dampers controlled by a thermostat in each apartment. It is generally understood that a central boiler or furnace system is more energy efficient than using separate heaters in each apartment. This higher efficiency is good for the environment as well lowering the energy demands of the nation. Also, it is generally understood that the maintenance costs are less for a central boiler or furnace system than for multiple heating units.

However, since landlords are commonly responsible for the expense of centralized heating that is not allocated to individual tenants, the tenants have very little incentive to lower their thermostat settings when their apartments are un-occupied or during periods when the occupants are sleeping. It is a common complaint among landlords that when some tenants are gone for the day they leave windows open in cold weather, or leave the thermostats set to high temperatures. Without an individual time-stamped apartment heat consumption record to help allocate costs in a fair manner, the landlord has to charge a higher base rent for all of the tenants because some are careless.

There are several companies that market peripheral systems that can be added to personal computers to automate nearly anything from a home to a small factory, but they are quite expensive and come with software that provides little more than isolated output data from individual sensors. The software to provide an integrated solution to pro-rating the cost of utilities in a building with a plurality of units would have to be developed by the end user of these systems because the included software is not suited to the purpose.

Accordingly, there is a need for an easily installed and monitored integrated system that will help a user determine the pro-rata share of the heating cost for each of the units in a building with centralized heating. There is an additional need for the integrated system to provide features that allow a user to verify that heat has been properly delivered to the units in accordance with their calculated pro-rata share as an audit measure. There is a further additional need for the integrated system to provide a notice to the user if the system detects a fault condition in the heating system's operation.

### SUMMARY OF THE INVENTION

The present invention provides systems and methods for monitoring utility usage for a plurality of units in a building. The system includes a controller and one or more sensing devices in signal communication over existing building thermostat wiring with the controller for sensing the state of a thermostat in each of the plurality of units and an air temperature reading near the thermostat. An additional sensor monitors the temperature of piping or ducting leading from a thermostatically controlled supply valve to the unit requesting heat to verify that heat is being delivered as requested. Conducting temperature and/or other signal communications over existing building thermostat wiring is a feature that allows for easier installation than if independent communication lines had to be installed to the thermostats in each unit. The controller records utility usage information for each of the plurality of units based on information received from the one or more sensing devices.

### BRIEF DESCRIPTION OF THE DRAWINGS

Preferred and alternative embodiments of the present invention are described in detail below with reference to the following drawings.

FIG. 1 is a diagram showing an embodiment of the present invention.

FIG. 2 is a diagram showing additional detail for the temperature sensor system shown in FIG. 1 in accordance with an embodiment of the invention.

FIG. 3 is a diagram showing additional detail for an example embodiment of the controller, sensor selector and signal demultiplexing device shown in FIG. 1.

FIG. 4 is a diagram showing additional detail for an example embodiment of the thermostat state sensor selector shown in FIG. 3.

FIG. 5 is a diagram showing additional detail for an example embodiment of the temperature sensor selector shown in FIG. 3.

FIG. 6 is a diagram showing additional detail for an example embodiment of the digital converter shown in FIG. 5.

### DETAILED DESCRIPTION OF THE PREFERRED EMBODIMENTS

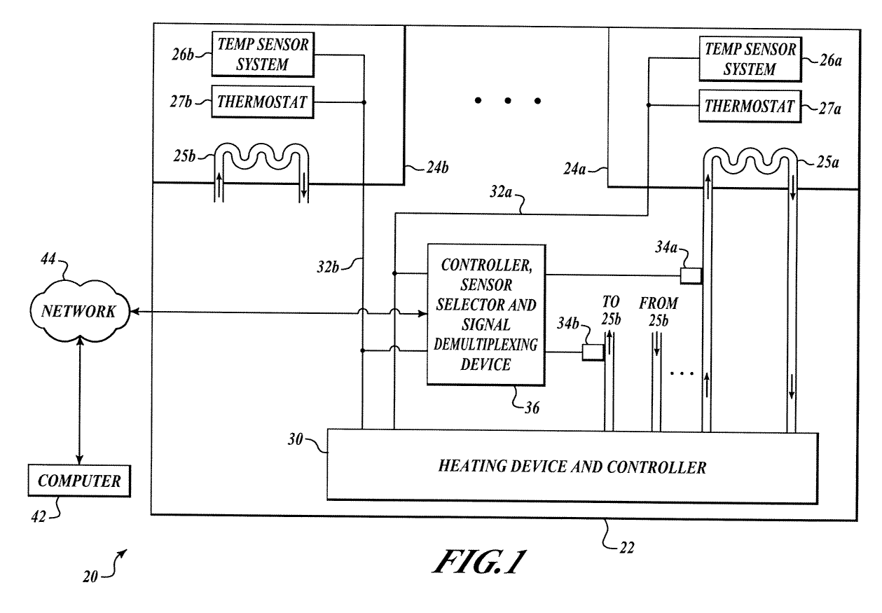

FIG. 1 is a diagram showing an embodiment of the present invention. A system 20 for monitoring and recording utility usage information in a building 22 having a plurality of spaces 24a, 24b to be monitored includes an on-site component located within the building 22 and an off-site component located external to the building 22. In an alternative embodiment, the centrally supplied utility is supplied to spaces 24a, 24b that are located in a plurality of buildings 22 such that monitoring and recording occurs for spaces in a building complex rather than in a single building. Each space 24a, 24b includes a temperature sensor system 26a, 26b for monitoring air temperature in the space 24a, 24b and a thermostat 27a, 27b. In one embodiment, the temperature sensor systems 26a, 26b monitor air temperature near the thermostats 27a, 27b. The spaces 24a, 24b may be apartments, individual rooms, common areas, units or other spaces using a centrally supplied utility. The spaces 24a, 24b also may be zones of multiple areas of the building 22.

In this embodiment, the centrally supplied utility is supplied using a heating device and controller 30 that distributes heat to radiators 25a, 25b located in the spaces 24a, 24b. The thermostats 27a, 27b are connected to the heating device and controller 30 via thermostat wires 32a, 32b. When the thermostats 27a, 27b are “ON” and thus requesting that heat be delivered to the spaces 24a and 24b, the thermostats 27a, 27b cause a 60 Hz 24 Vac current to flow on the thermostat wires 32a, 32b. The voltage level and frequency of the current may be different in other embodiments. This 24 Vac current is directed to an actuator located on a zone valve (not shown) in the heating device and controller 30 that corresponds to the space 24a, 24b in which the thermostat 27a, 27b is “ON”. The actuated zone valve then allows heated water, steam or air, depending on the type of heating system to pass from a boiler or other heating device through the actuated zone valve to the radiator 25a, 25b in the space 24a, 24b in which the thermostat 27a, 27b is “ON”. Heat distribution devices other than radiators may be used in other embodiments as well.

Temperature sensors 34a, 34b located on heating pipes and/or air ducting leading from zone valves (not shown) and/or ducting dampers (not shown) are used to verify that heat is delivered to the radiators 25a, 25b as requested by the thermostats 27a, 27b. The temperature sensors 34a, 34b have operating ranges that correspond to the type of heating system being used. For example, a system using steam may require temperature sensors 34a, 34b with higher operating ranges than a system using hot water. Additionally, if a different type of utility is supplied in other embodiments, sensors other than temperature sensors are employed to verify proper delivery of the utility.

A controller, sensor selector, and signal demultiplexing device 36 is in signal communication with the temperature sensor systems 26a, 26b and thermostats 27a, 27b via thermostat wiring 32a, 32b. However, in other embodiments installed in new construction, for example, the temperature sensor systems 26a, 26b could be directly wired to the controller, sensor selector, and signal demultiplexing device 36 which allows the thermostat wiring 32a, 32b to be used to monitor an additional type of input if desired. In some embodiments, the controller, sensor selector, and signal demultiplexing device 36 fits in a standard sized National Electrical Manufacturers Association (NEMA) industrial enclosure where it can be protected from the dust and dirt environment of a boiler or furnace room. The thermostats 27a, 27b can be easily monitored by the controller, sensor selector, and signal demultiplexing device 36 because thermostats are binary devices (on or off). The controller, sensor selector, and signal demultiplexing device 36 is also in signal communication with the temperature sensors 34a, 34b. In this embodiment, the controller, sensor selector, and signal demultiplexing device 36 is directly wired to the temperature sensors 34a, 34b. However, in other embodiments, the temperature sensors 34a, 34b may be in signal communication with the controller, sensor selector, and signal demultiplexing device 36 using other means such as RF communications.

In one embodiment, the thermostat state for each thermostat 27a, 27b is recorded once per second for each space 24a, 24b. The controller, sensor selector, and demultiplexing device 36 also stores values for information received from the temperature sensor systems 26a, 26b and the temperature sensors 34a, 34b once per second in this example along with a time stamp indicating when the measurement was taken. Once per hour, the controller, sensor selector, and signal demultiplexing device 36 accumulates the total seconds of “ON” thermostat states and records an hourly utility usage record for each space 24a, 24b.

The off-site component of the system 20 includes a computer 42 that is in data communication with the controller, sensor selector and signal demultiplexing device 36 via a network 44. In some embodiments, the network 44 is a telephone network and the computer 42 communicates with the controller, sensor selector, and signal demultiplexing device 36 using a modem. In other embodiments, the network 44 is a public or private data network such as the Internet and the computer 42 communicates with the controller, sensor selector, and signal demultiplexing device 36 using a network interface. The controller, sensor selector, and signal demultiplexing device 36 also communicates audio information to a user via a telephone handset (not shown) reached over the network 44 in some embodiments. The computer 42 is a standard general purpose personal computer in one embodiment that includes a processor, memory, secondary storage, communications means, keyboard, mouse, and display device.

The computer 42 is used to access the hourly utility usage records via one or more of the communications methods mentioned above. The hourly records for the month are processed by the computer 42 to determine the total number of “heating seconds” requested by each space 24a, 24b as well as the total “heating seconds” requested by all of the spaces 24a, 24b. The fractional share of the total building's 22 monthly heating bill for each space 24a, 24b is the same as the fractional share of the space's 24a, 24b “heating seconds” are to the total “heating seconds” for all the building's 22 spaces 24a, 24b. In this embodiment, remote access by the computer 42 to the controller, sensor selector, and signal demultiplexing device 36 is password protected and the data output is encoded to provide security for the overall operation of the system. However, these protections may not be in place in other embodiments.

In one embodiment, a property manager for the building 22 receives a monthly statement indicating the heat consumption of each space 24a, 24b for every hour of every day, which allows the property manager to bill the tenants for what they have actually used. An hourly time stamped temperature data record of the piping temperature from the temperature sensors 34a, 34b and the temperature at the thermostat from the temperature sensor systems 26a, 26b along with the thermostat 27a, 27b states for each space 24a, 24b provides a time stamped audit trail, confirming that each space 24a, 24b has actually received the heat for which they are being charged. Any fault conditions detected during normal operation of the system can be passed to the property manager as a voice message via a MODEM generated telephone call by the controller, sensor selector, and signal demultiplexing device 36 enabling prompt repairs to be scheduled as required.

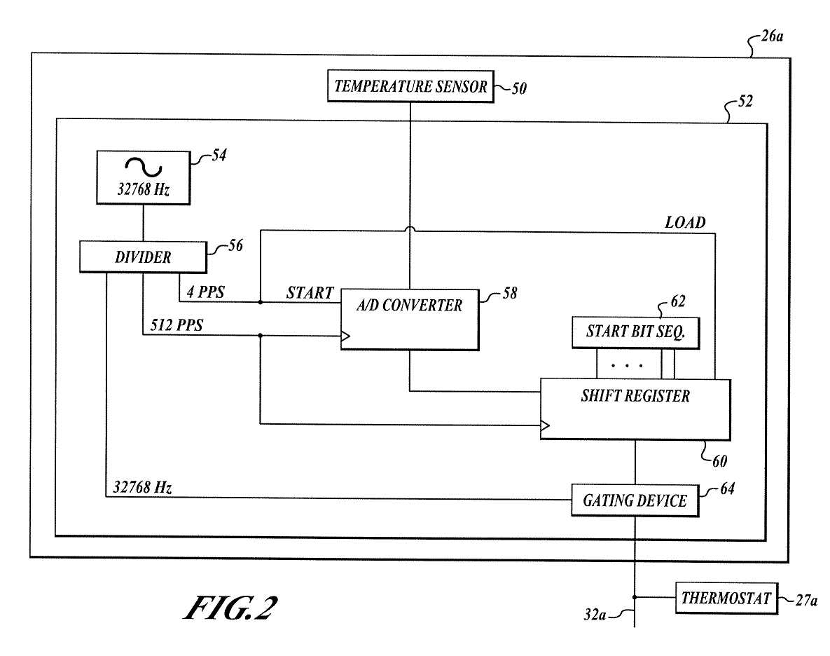

FIG. 2 is a diagram showing additional detail for the temperature sensor system 26a shown in FIG. 1 in accordance with an embodiment of the invention. The temperature sensor system 26a includes a temperature sensor 50 that produces an analog signal proportional to the temperature being sensed. This analog signal is converted to a digital value by a serial output analog to digital (A/D) converter 58. A 32768 Hz crystal 54 controls a 14 stage binary divider 56 with a built-in oscillator. The divider 56 provides a signal with 4 falling pulse edges per second (pps) (the conversion clock) at a first output pin, a signal with 512 pps (the bit clock) at a second output pin, and the oscillator output of 32768 Hz at a third pin. The falling edge of the conversion clock triggers the A/D converter 58 to start a conversion of the analog signal from the temperature sensor 50 and loads a start bit sequence 62 into a parallel load shift register 60 at the same time. The A/D converter 58 and the shift register 60 are clocked together by the 512 pps signal produced by the divider 56. As the shift register 60 is clocked, the loaded bits are shifted out at one end and the data bits from the A/D converter 58 are shifted in at the other end. Eventually the shift register 60 contains only data bits from the A/D converter 58 output pin. After all of the A/D data bits are passed through the shift register 60, the output of the shift register 60 becomes a string of binary “0's”. While this shifting process is going on, the shift register 60 output bit controls the gating of the 32768 Hz signal from the divider 56 onto the thermostat wire 32a at a gating device 64. The gating device 64 places a 32768 Hz tone on the thermostat wire 32a if a binary “1” is present at the shift register 60 output. No tone is passed on the thermostat wire 32a if a binary “0” is present at the shift register 60 output.

When the thermostat 27a is “ON”, and requesting that more heat be delivered to the space 24a, a 24 Vac current is present on the thermostat wire 32a. When the thermostat 27a is “OFF”, the 24 Vac current is not present. The gated tones can be placed on the thermostat wire 32a regardless of whether the 24 Vac current is present on the thermostat wire 32a. Both the 24 Vac current, when present, and the serial tone signals from the gating device 64 are carried on the thermostat wire 32a. The presence or lack of 24 Vac indicates the state (on/off) of the thermostat 27a and the pattern of 32768 Hz tones represents the temperature sensed by the temperature sensor 50.

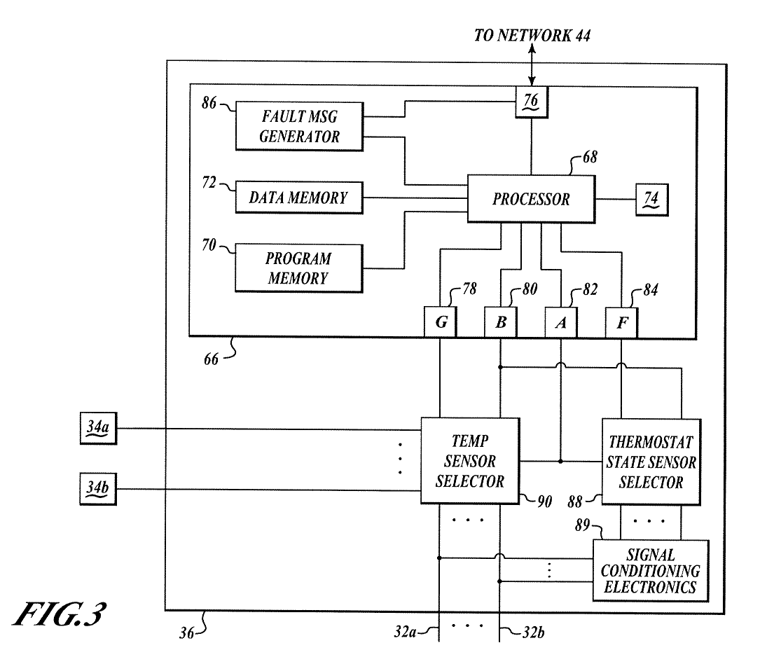

FIG. 3 is a diagram showing additional detail for an example embodiment of the controller, sensor selector and signal demultiplexing device 36 shown in FIG. 1. The controller, sensor selector and signal demultiplexing device 36 includes a controller 66, a thermostat state sensor selector 88, signal conditioning electronics 89, and a temperature sensor selector 90. The controller 66 includes: a processor 68; a program memory unit 70 in data communication with the processor 68; a data memory unit 72 in data communication with the processor 30; a plurality of input/output (I/O) ports in data communication with the processor 68, including a Port G 78, a Port B 80, a Port A 82, and a Port F 84; a fault message generator 86 in data communication with the processor 68; a communications device 76 in data communication with the processor 68 and in signal communication with the fault message generator 86; and a 32768 Hz crystal 74 in signal communication with the processor 68. In other embodiments, there may be greater or lesser numbers of ports and the ports may be designated as input or output specific ports rather than I/O ports. For example, in one embodiment, a Rabbit 3000 microprocessor by Rabbit Semiconductor is used that includes seven I/O ports.

The temperature sensors 34a, 34b and the temperature sensor systems 26a, 26b are in signal communication with the controller 66 via the temperature sensor selector 90, which receives signals from the temperature sensors 34a, 34b and the temperature sensor systems 26a, 26b as inputs. The signal communications from the temperature sensors 34a, 34b are directly wired to the temperature sensor selector 90 and the signals from the temperature sensor systems 26a, 26b are transmitted to the temperature sensor selector 90 over existing building 22 thermostat lines 32a, 32b in this embodiment. However, in other embodiments, the signal communications from the temperatures sensor systems 26a, 26b are transmitted using wireless radiofrequency (RF) communications or other means. The controller 66 is in data communication with the temperature sensor selector 90 using Ports G 78, B 80, and A 82. The controller 66 is in data communication with the thermostat state sensor selector 88 using ports B 80, A 82, and F 84. The controller 66 selects thermostat states from particular spaces 24a, 24b using the thermostat state sensor selector 88. Thermostat states from the thermostats 27a, 27b enter the thermostat state sensor selector 88 via signal conditioning electronics 89. The controller 66 selects input from the temperature sensors 34a, 34b, temperature sensor systems 26a, 26b, and the thermostats 27a, 27b, by using one or more output values presented at the Ports G 78, B 80, and F 84 by the processor 68 as one or more inputs to the temperature sensor selector 90 and the thermostat state sensor selector 88.

The signal conditioning electronics 89 condition the 24 Vac signal from the thermostat wires 32a, 32b supplied to actuators on zone valves (not shown) by the thermostats 27a, 27b. First, the voltage is reduced to a level more compatible with the nominal 5 Vdc operating voltage of digital Integrated Circuits (IC's) with a simple resistor divider circuit (not shown). Then, the AC voltage is rectified and diode detected before being smoothed with a storage capacitor (not shown). The decay time is controlled with a resistor to signal ground (not shown) across the storage capacitor. This provides a DC voltage with a rise and fall time of less than the sampling interval desired as the voltage is turned on and off by the thermostats 27a, 27b. This DC voltage is used to supply the driving current for an optical isolator IC (not shown) to generate a logic level signal provided as an output from the signal conditioning electronics 89 to the thermostat state sensor selector 88.

The crystal 74 drives a real-time clock function in the processor 68. The clock provides the year, month, day and time of day in hours, minutes and seconds when requested by a software program running on the processor 68 by using a library function supplied by the manufacturer of the controller 66. This time value is used to time stamp the collected data by recording the time value when readings from the temperature sensors 34a and 34b, temperature sensor systems 26a and 26b, and thermostat states from thermostats 27a and 27b are stored in the data memory unit 72. Other approaches to generating a real-time clock could be used in other embodiments as there are several ICs that provide an external real-time clock that can be read by a controller.

The controller 66 stores the selected input from the temperature sensors 34a, 34b; temperature sensor systems 26a, 26b; and the thermostats 27a, 27b in the data memory unit 72 as raw sensed values. The raw sensed values are marked with a time stamp in some embodiments to indicate when the values were collected. In some embodiments, the processor 68 accumulates some of the stored raw sensed values after a defined time period has elapsed before storing an accumulated value and a corresponding time in the data memory unit 72. For example, in some embodiments, thermostat state values are collected once per second and stored as raw values. However, the processor 68 accumulates the stored raw values each hour to determine the number of seconds in that hour that the thermostat state was set to “ON”. This “ON” seconds per hour value is then stored in the memory unit 32. A time stamp is also stored along with the number of “ON” seconds so a user will know the time period for which the “ON” seconds value is valid. In addition to storing the number of “ON” seconds for each hour, the processor 68 stores an hourly maximum temperature value and an hourly minimum temperature value in the data memory unit 72 for each of the temperature sensor systems 26a, 26b and temperature sensors 34a, 34b in some embodiments. The maximum and minimum temperature values are updated by the processor 68 during the course of each hour if a newly retrieved value is found to be above the previous maximum temperature value for that hour or below the previous minimum temperature value for that hour. Additionally, an hourly average temperature is calculated using each pair of maximum and minimum temperature values and stored in the data memory unit 72 by the processor 68 in some embodiments.

The controller 66 may communicate with the computer 42 over the network 44 via the communications device 76. In some embodiments, the communications device 76 is a modem. In other embodiments, the communications device may be a wired or wireless network interface. In embodiments where the computer 42 communicates with the controller 66 with a directly dialed modem connection, the network 44 is a phone network. In other embodiments, the network 44 is a wired and/or wireless network such as the Internet or an IEEE 802.11 a, b, g, or n network, for example. In still other embodiments, the computer 42 may connect directly to the controller 66.

The computer 42 can also be used to remotely configure the controller, sensor selector, and signal demultiplexing device 36. Remote configuration is accomplished by sending at least one of a plurality of constant values from the computer 42 to the processor 66 over the network 44 using any of a number of different devices and/or communication protocols. Some of the parameters that can be configured remotely include: the system serial number for unique identification of the system, the number of thermostat valves or thermostat wires 32a, 32b to read, the number of analog sensor inputs such as temperature sensors 34a, 34b to read, the number of multiplexed/demultiplexed sensor inputs such as the signals coming from temperature sensor systems 26a, 26b to read, the phone number to call if the system detects a fault, the system password, and sensor limits. Additionally, the date and time can be verified and the clock can be corrected remotely, collected data can be downloaded to verify correct operation of the system at any time, and old data can be erased from data memory if desired.

The fault message generator 86 generates fault messages based on a number of triggering events. The triggering events can be grouped broadly into type 1 faults and type 2 faults. Type 1 faults are supply faults and occur when a resource is requested but not delivered, such as might be caused by a valve being stuck in an “OFF” position, or when a resource is provided that was not requested, such as might be caused by a valve being stuck in an “ON” position. Type 2 faults are limit violations and occur, for example, if an extremely hot or cold temperature is detected. In embodiments where other types of sensors are used such as humidity sensors or particular types of gas sensors, a limit violation may also be a humidity level exceeding a specified threshold value or a detected explosive or toxic gas concentration. Type 1 faults are found by the processor 68 monitoring the requesting space 24a, 24b piping using temperature sensors 34a, 34b and monitoring the temperature of the space using the temperature sensor system 26a, 26b and comparing the monitored temperatures with the thermostat 27a, 27b state of the space 24a, 24b. If it is found that the thermostat 27a, 27b is requesting heat by having an “ON” thermostat state and the supply piping temperature and space 24a, 24b temperature do not reflect that heat is being delivered to the space 24a, 24b, the processor 68 triggers the fault message generator 86. In similar fashion, if the thermostat 27a, 27b is in an “OFF” state and the supply piping for the space 24a, 24b remains at a high temperature and the space 24a, 24b continues to increase in temperature or maintain a high temperature, the processor 68 may trigger the fault message generator 86. If either of the last two discussed triggering events occur for isolated spaces 24a, 24b they likely signify that a valve is stuck “OFF” or “ON” respectively. If no heat is found being delivered to all spaces 24a, 24b, a general fault with the heating device and controller 30 is likely. For type 2 limit violations, the sensor limits are stored values entered when the system 20 is configured and are used as comparison values. If the processor 68 detects a measured value above or below particular set limit values, the processor 68 triggers the fault message generator 86 to send a fault message.

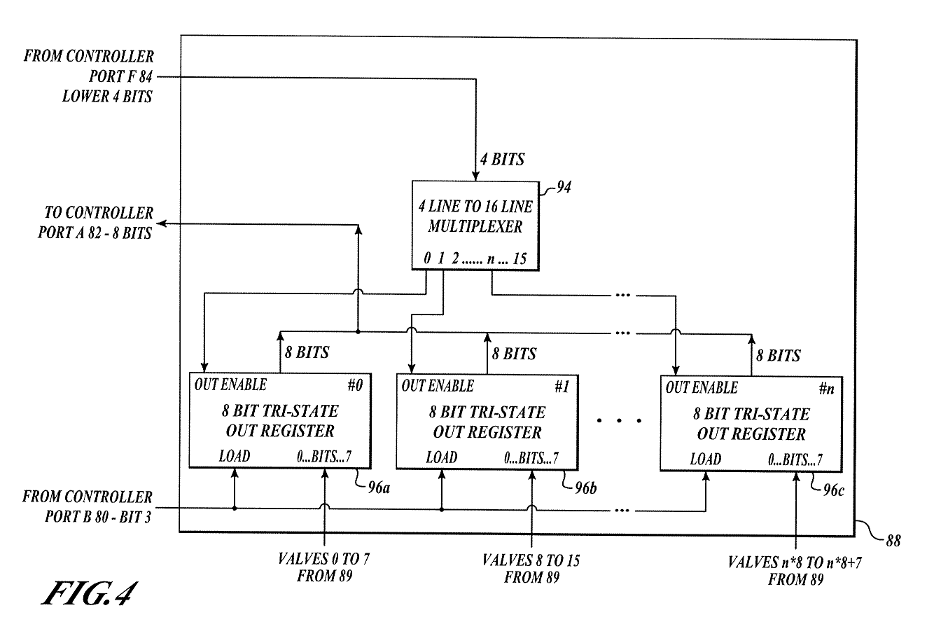

FIG. 4 is a diagram showing additional detail for an example embodiment of the thermostat state sensor selector 88 shown in FIG. 3. The thermostat state sensor selector 88 includes a thermostat state sensor multiplexer 94. In this embodiment, the thermostat state sensor multiplexer 94 is a four to sixteen line multiplexer. The four input bits of the thermostat state sensor multiplexer 94 are received from the lower four bits of the controller 66 Port F 84. The thermostat state sensor multiplexer 94 includes 16 outputs, each one of which is used as an output enable input to a tri-state out register. Not all of the tri-state out registers are shown in the diagram for clarity, but a first tri-state out register 96a, a second tri-state out register 96b, and a third tri-state out register 96c are shown as examples. The number of tri-state out registers 96a, 96b, 96c varies from embodiment to embodiment depending on the number of thermostat states that need to be sensed. For fewer spaces 24a, 24b, and thus fewer states, fewer tri-state out registers 96a, 96b, 96c are used. In addition to an output enable input, each tri-state out register 96a, 96b, 96c has an eight bit input, with each bit of the eight bit input indicating a single thermostat state of “ON” or “OFF” corresponding to the thermostats 27a, 27b in each of the plurality of spaces 24a, 24b. Each bit of the eight bit input will be a binary ‘0’ if the corresponding thermostat state is “OFF” and will be a binary ‘1’ if the corresponding thermostat state is “ON”.

The thermostat states are transmitted to a plurality of control valves (not shown) corresponding to the thermostats 27a, 27b over the thermostat wires 32a, 32b. The control valves are numbered starting with zero in this example, so the first tri-state out register 96a corresponds to thermostat states associated with valves 0 to 7 and the second tri-state out register 96b corresponds to thermostat states associated with valves 8 to 15. The eight bit inputs to the tri-state out registers 96a, 96b, and 96c are locked in place with a load input at each tri-state out register. The load inputs of all the tri-state out registers 96a, 96b, 96c are controlled by bit 3 of the Port B 80 output from the controller 66 in this example. After the thermostat states have been loaded in the tri-state out registers 96a, 96b, and 96c, they are presented eight at a time when the output enable input of each tri-state out register is toggled on by the input received from the thermostat state sensor multiplexer 94. The eight thermostat state values are then received as inputs by the Port A 82 so they can be processed and/or stored by the controller 66.

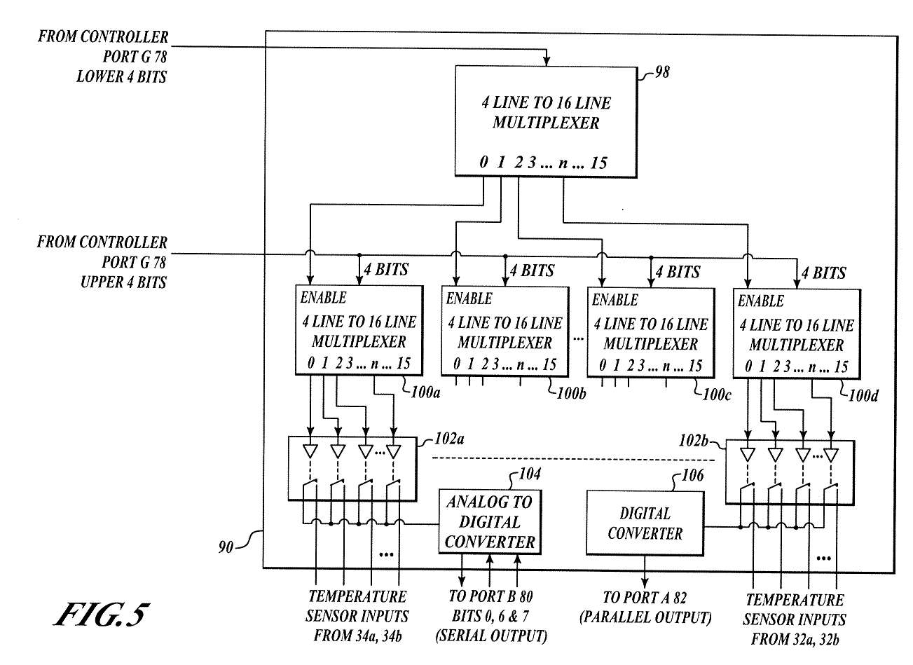

FIG. 5 is a diagram showing additional detail for an example embodiment of the temperature sensor selector 90 shown in FIG. 3. In this embodiment, the Ports G 78, B 80, and A 82 from the controller 66 as discussed with reference to FIG. 3 are used. The temperature sensor selector 90 includes a temperature data multiplexer selector 98. In this embodiment, the temperature data multiplexer selector 98 is a four to sixteen line multiplexer. The four input bits of the temperature data multiplexer selector 98 are received from the lower four bits of the Port G 78 of the controller 66. Each of the sixteen output bits of the temperature data multiplexer selector 98 is used as an enable input to one of a series of temperature data multiplexers, only four of which are shown for clarity as temperature data multiplexers 100a, 100b, 100c, and 100d. Fewer or greater numbers of temperature data multiplexers may be used in other embodiments. The temperature data multiplexers 100a, 100b, 100c, and 100d are four to sixteen line multiplexers in this example. The four input bits for the temperature data multiplexers 100a, 100b, 100c, and 100d are received from the upper four bits of the Port G 78 of the controller 66 on a common bus.

Each temperature data multiplexer 100a, 100b, 100c, and 100d has a sixteen bit output. Each bit of the sixteen bit output is associated with a temperature sensor input. In this example, the temperature data multiplexers 100a and 100b are used to multiplex analog temperature signals received from the temperature sensors 34a, 34b and the temperature data multiplexers 100c and 100d are used to multiplex the temperature signals received on the thermostat wires 32a, 32b that were generated by the temperature sensor systems 26a, 26b. Each temperature data multiplexer 100a, 100, 100c, and 100d is associated with a digitally controlled analog sensor selector 102a, 102b, each of which corresponds to a group of temperature sensor inputs. Only two sensor selectors 102a, 102b are shown for clarity. In this example, the sensor selector 102a corresponds to the temperature data multiplexer 100a and the sensor selector 102b corresponds to the temperature data multiplexer 100d. The sensor selector 102a directs one of the analog temperature inputs presented by the temperature sensors 34a, 34b to an A/D converter 104. Although the connections are not shown, the temperature data multiplexer 100b is also connected to a sensor selector that directs analog temperature data to the A/D converter 104 with a serial output. In this embodiment, the serial output of the A/D converter 104 is received by the Port B 80 bit 0 of the controller 66. Bits 6 and 7 from Port B 80 are used as inputs to the A/D converter 104. Bit 6 serves as a start convert signal and bit 7 is used to clock the serial data out of the A/D converter 104. The sensor selector 102b directs one of the temperature sensor inputs from the thermostat wires 32a, 32b to a digital converter 106 with a parallel output. In this embodiment, the parallel output of the digital converter 106 is received by the Port A 82 of the controller 66. Although the connections are not shown, the temperature data multiplexer 100c is also connected to a sensor selector that directs temperature data from thermostat wires to the digital converter 106.

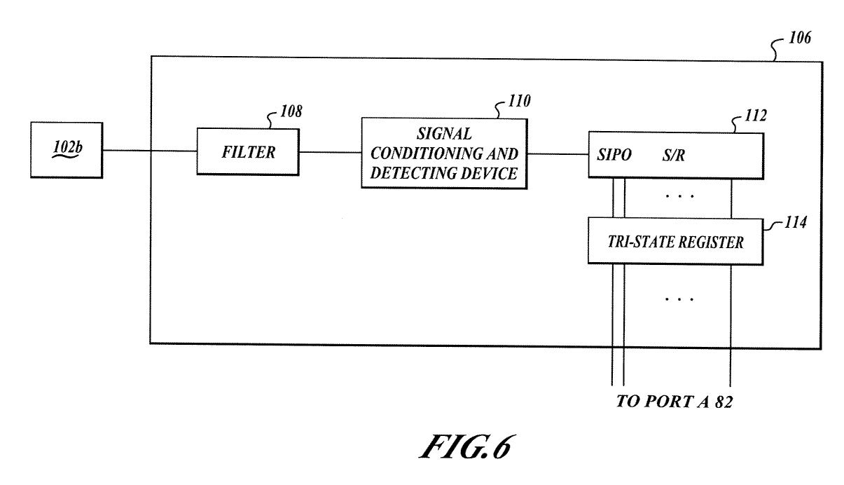

FIG. 6 is a diagram showing additional detail for an example embodiment of the digital converter 106 shown in FIG. 5. The digital converter 106 receives the output of the sensor selector 102b as an input. Although not shown, the digital converter 106 receives the output of additional sensor selectors in other embodiments. The input to the digital converter 106 contains the serial tone sequence generated by one of the temperature sensor systems 26a, 26b. After entering the digital converter 106, the input signal is passed through a filter 108 tuned to 32768 Hz to remove any detectable trace of the 60 Hz signal that might be present on the 24 Vac thermostat wire 32a, 32 b. Next, at a signal conditioning and detecting device 110, the signal is rectified, detected and smoothed in a way similar to that employed by the signal conditioning electronics 89 used for the thermostat state inputs as discussed with reference to FIG. 3. However, the signal conditioning and detecting device 110 does not use a resistor divider circuit as in the signal conditioning electronics 89 because the 60 Hz 24 Vac signal has already been removed by the filter 108.

The signal conditioning and detecting device 110 converts the detected signal into a logic level digital stream of binary “1's” and “0's”. The digital stream from the signal conditioning and detecting device 110 then enters a serial input, parallel output shift register 112. The timing of the receiving shift register 112 is generated by using a 14 bit divider IC (not shown) with a 32768 Hz crystal controlled oscillator (not shown). This provides the same shift clock frequency used in the temperature sensor systems 26a, 26b to generate the pattern of 32768 Hz tones on the thermostat lines 32a, 32b. The start bit sequence 62 arrives first and is followed by the A/D data bit stream. When the start bit sequence 62 arrives at the far end of the shift register 112, it is detected with a multiple input AND gate (not shown) that triggers the storage of the following A/D data bits into a parallel load tri-state buffer register 114, where the data bits are held until being read in via Port A 82 by the controller 66 so they can be processed and/or stored.

While the preferred embodiment of the invention has been illustrated and described, as noted above, many changes can be made without departing from the spirit and scope of the invention. For example, the invention could be used to monitor usage of water, gas, or electrical power in addition to heat. The invention could also be used to detect for the presence of certain hazards such as gas leaks or fire. Also, the crystal 54 and the crystal 74 as well as other components of the system could use frequencies other than 32768 Hz in other embodiments. Additionally, a data bus could be used for communications between parts of the system. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for recording utility usage of a plurality of units in a building comprising:
a controller, comprising:
a processor;
at least one memory unit in data communication with the processor;
at least one port in data communication with the processor; and
a communications means in data communication with the processor for communicating data at least one of to or from a network; and
a sensing device in signal communication with the controller via the port, the sensing device comprises:
a first component for periodically sensing the state of a thermostat in each of the plurality of units using previously existing building thermostat wiring,
wherein the controller records the sensed thermostat state for each of the plurality of units in the at least one memory unit.

2. The system of claim 1, wherein the sensing device further comprises a second component for periodically sensing the temperature of at least one of a pipe or a duct after an output side of at least one of a zone valve or a ducting damper leading to each of the plurality of units, and wherein the controller records the sensed temperature for each of the plurality of units and generates an audit trail based on at least one of the sensed temperature and the sensed thermostat states.

3. The system of claim 2, wherein the sensing device further comprises a third component for periodically sensing the air temperature in each of the plurality of units in signal communication with the controller using the building thermostat wiring, and wherein the controller also records the sensed air temperature for each of the plurality of units and generates the audit trail further based on the sensed air temperature.

4. The system of claim 1, wherein the thermostat wiring includes low voltage wiring used to transmit a 24 VAC current.

5. The system of claim 1, wherein the communications means includes a modem for connecting the controller to a telephone network.

6. The system of claim 1, wherein the first component of the sensing device comprises:
a thermostat state sensor selector for selecting at least one of a plurality of thermostat state sensors for retrieval of thermostat state information, and wherein the processor comprises:
a first component configured to periodically retrieve a current thermostat state from one or more of the plurality of thermostat state sensors via the thermostat state sensor selector; and
a second component configured to store the retrieved thermostat states in the memory unit.

7. The system of claim 6, wherein the second component of the sensing device comprises:
a plurality of temperature sensors positioned such that each temperature sensor senses the temperature of a previously existing heating system output; and
the sensing device further comprises:
a temperature sensor selector for selecting at least one of the temperature sensors for retrieval of temperature sensor information,
wherein the controller also records sensed temperature based on information received from the temperature sensors.

8. The system of claim 7, wherein the third component of the sensing device comprises:
a plurality of temperature sensing devices positioned such that each temperature sensing device senses the air temperature of a unit,
wherein the temperature sensor selector is also for selecting at least one of the temperature sensing devices for retrieval of temperature sensing device information, and wherein the controller also records sensed temperature from the third component based on information received from the temperature sensing devices.

9. The system of claim 8, wherein the thermostat state sensor selector includes a multiplexer, and the temperature sensor selector includes a multiplexer.

10. The system of claim 9, wherein:
the thermostat state sensor selector is in data communication with the controller via one of the input ports and via one of the output ports; and
the temperature sensor selector is in data communication with the controller via one of the input ports and via one of the output ports.

11. The system of claim 10, wherein the processor further comprises:
a third component configured to periodically retrieve a first temperature reading from each of the temperature sensors via the temperature sensor selector;
a fourth component configured to store the retrieved first temperature readings in the memory unit;
a fifth component configured to periodically retrieve a second temperature reading from each of the temperature sensing devices via the temperature sensor selector; and
a sixth component configured to store the retrieved second temperature readings in the memory unit.

12. The system of claim 11, wherein the processor further comprises:
a seventh component configured to transmit at least one of the stored thermostat state, first temperature reading, second temperature reading data, or generated audit trail via the communications means.

13. The system of claim 12, wherein the processor further comprises:
an eighth component configured to identify a fault in system operation based on at least one of the sensed thermostat states, sensed first temperature values, and the sensed second temperature values; and
a ninth component configured to transmit a fault detection notice to a user via the communications means if a fault is identified.

14. The system of claim 13, wherein the fault detection notice includes an audio alert created using a previously stored audio file of a human voice.

15. A method comprising:
periodically sensing states of a plurality of thermostats located in units of a building using previously existing building thermostat wiring;
transmitting the sensed thermostat states to a controller; and
storing the thermostat states in a memory unit associated with the controller.

16. The method of claim 15, further comprising:
receiving a request at the controller from a requestor; and
transmitting the stored thermostat states in response to the request.

17. The method of claim 16, further comprising:
periodically sensing a plurality of heating system output temperatures as first temperature values;
periodically sensing a plurality of room temperatures as second temperature values;
transmitting the sensed first temperature values to the controller;
transmitting the sensed second temperature values to the controller over the previously existing thermostat wiring system;
storing the received first temperature values in a memory unit associated with the controller;
storing the received second temperature values in a memory unit associated with the controller;
transmitting the stored first temperature values in response to the request; and
transmitting the stored second temperature values in response to the request.

18. The method of claim 17, wherein the request is received at a modem associated with the controller and the stored thermostat states, first temperature values, and second temperature values are transmitted to the requester via the modem.

19. The method of claim 18, further comprising:
identifying a system fault based on at least one of the sensed thermostat states, sensed first temperature values, and sensed second temperature values; and
transmitting a fault detection notice to a user.

20. The method of claim 19, wherein the fault detection notice is an audio alert using an electronically recorded human voice.
